(19) United States
(12) Patent Application Publication
(10) Pub. No.: US 2012/0060353 A1
(43) Pub. Date: Mar. 15, 2012

(54) MECHANISM AND METHOD FOR ENSURING ALIGNMENT OF A WORKPIECE TO A MASK

(75) Inventor: Jeffrey E. Krampert, Topsfield, MA (US)

(73) Assignee: Varian Semiconductor Equipment Associates, Inc., Gloucester, MA (US)

(21) Appl. No.: 12/881,653

(22) Filed: Sep. 14, 2010

(51) Int. Cl. B23Q 7/00; B23Q 3/00

(52) U.S. Cl. 29/559; 269/19

(57) ABSTRACT

A workpiece support having alignment features to allow the proper alignment of the shadow mask to the workpiece is provided. The alignment features include tactile sensors, so as to measure the pressure being applied to each alignment feature. Based on these pressure readings, a determination can be made as to whether the workpiece is properly aligned with the shadow mask. In some embodiments, corrective actions may be initiated if a determination is made that the workpiece is not properly aligned.

### FIELD

This disclosure relates to a method and mechanism for ensuring the alignment of a workpiece to a mask, such as a shadow mask for use in an ion implantation process.

### BACKGROUND

An electronic device may be created from a workpieces that has undergone various processes. One of these processes may include introducing impurities or dopants to alter the electrical properties of the original workpiece. For example, charged ions, as impurities or dopants, may be introduced to a workpiece, such as a silicon wafer, to alter electrical properties of the workpiece. One of the processes that introduces impurities to the workpiece may be an ion implantation process.

An ion implanter is used to perform ion implantation or other modifications of a workpiece. A block diagram of a conventional ion implanter is shown in FIG. 1. Of course, many different ion implanters may be used. The conventional ion implanter may comprise an ion source 102 that may be biased by a power supply 101. The system may be controlled by controller 120. The operator communicates with the controller 120 via user interface system 122. The ion source 102 is typically contained in a vacuum chamber known as a source housing (not shown). The ion implanter system 100 may also comprise a series of beam-line components through which ions 10 pass. The series of beam-line components may include, for example, extraction electrodes 104, a 90° magnet analyzer 106, a first deceleration (D1) stage 108, a 70° magnet collimator 110, and a second deceleration (D2) stage 112. Much like a series of optical lenses that manipulate a light beam, the beam-line components can manipulate and focus the ion beam 10 before steering it towards a workpiece or wafer 114, which is disposed on a workpiece support 116.

In operation, a workpiece handling robot (not shown) disposes the workpiece 114 on the workpiece support 116 that can be moved in one or more dimensions (e.g., translate, rotate, and tilt) by an apparatus, sometimes referred to as a “roplat” (not shown). Meanwhile, ions are generated in the ion source 102 and extracted by the extraction electrodes 104. The extracted ions 10 travel in a beam-like state along the beam-line components and implanted on the workpiece 114. After implanting ions is completed, the workpiece handling robot may remove the workpiece 114 from the workpiece support 116 and from the ion implanter 100.

Referring to FIG. 2, there is shown a block diagram illustrating one embodiment of a workpiece support 116 used to support the workpiece 114 during the ion implantation process. In this embodiment, the workpiece 114 is mounted on a platen 175, such as by electrostatic force. The platen 175 is rotatably connected to structure 185. In some embodiments, the platen 175 is hinged to structure 185 such that the platen 175 and workpiece 114 may pivot along path 183. For clarity, the axis about which the platen 175 rotates is referred to as the x-tilt axis, and allows the workpiece to be tilted to allow angled implants. In some embodiments, the structure 185 is also able to rotate about a second axis 182, known as the y-axis tilt axis. Using rotation about these two axes, it is possible to place the workpiece 114 at any desired angle relative to the ion beam 10. In some embodiments, the structure 185 may also be able to move up and down, such as parallel to second axis 182, in order to perform scanned implants. A controller 140 may be used to control the movements of the workpiece support 116. These movements may include the rotation of the platen 175 about the x-axis and y-axis. In other embodiments, this controller may also be used to control other functions, which may not be specific to the workpiece support 116.

In some embodiments, it is desirable to use a mask that has a fixed position relative to the platen. In some embodiments, the mask is fixed to the platen. In such instances, the mask is clamped to the platen, such as by mechanical means, such as a clamp. Any electrical connections can easily be made between the mask and the platen, since the mask is not moveable. In other embodiments, the mask is movable with respect to the platen. For example, a platen may be adapted to hold one of a plurality of masks. One of the masks may be selected, such as by a robotic arm, for placement on the platen. The mask may be aligned to the platen using techniques known to those of skill in the art. After the mask is placed on the platen, it may be secured, such as by a mechanical clamping mechanism. In addition, the alignment of the mask to the platen may also serve to provide a connection between electrical signals in the platen and in the mask. For example, one of more pins in the platen may be movable such that they are retracted while the mask is being placed on the surface of the platen. These pins may then be extended through the surface of the platen and contact the mask after the mask is properly clamped to the platen. In either embodiment, these pins may be used to supply power connections, such as voltage and ground to circuitry on the mask. In addition, one of more pins may be used to transmit data between the platen and the mask.

Two or more projections may be positioned on the mask which serve as alignment features. The workpiece is then placed on the platen, as described above. FIG. 3 shows a shadow mask 195 and a workpiece 114 located on a platen 175.

Alignment features 191, 192 are positioned on the underside of the shadow mask 195 to allow alignment with the workpiece 114 along one axis. These alignment features 191, 192 may serve to attach the shadow mask 195 to the platen 175. In other embodiments, the shadow mask 195 is held on the platen 175 using other means, such as using a clamping mechanism. In some embodiments, alignment features 193, 194 are also positioned on the underside of the shadow mask 195 to help align the workpiece 114 along an orthogonal axis. In this embodiment, the shadow mask 195 is assumed to be stationary, while the workpiece 114 can be moved relative to the shadow mask 195 and the alignment features 191-194. However, in other embodiments, the workpiece 114 may be kept in a fixed position and the shadow mask 195 may be moved relative to the workpiece 114.

In practice, the workpiece 114 is placed on the platen 175. The platen (with the shadow mask clamped thereto) is then typically tilted such that it is not horizontal, such that the platen 175 tilts allowing alignment features 191, 192 to be lower than the rest of the platen 175. This allows the workpiece 114 to slide relative to the platen 175 and the shadow mask 195 toward alignment features 191, 192. In some embodiments, a second tilting operation may be performed to align with alignment features 193, 194. In most embodiments, it is assumed that, by sufficiently tilting the platen 175 and holding it in the tilted position for an adequate amount of time, the workpiece 114 will move so that it abuts the alignment features 191-194 and is therefore properly aligned. However, in some cases, the workpiece 114 may not slide as expected, and is left misaligned after the tiling process is completed. Typically, this error is not detected until the workpiece 114 has been completely processed, thereby wasting process time and materials.

Therefore, it would be beneficial if there were a mechanism and method to ensure that the workpiece is indeed properly aligned with the shadow mask. This would reduce processing time, and improve yield, as the alignment process could be repeated if there was a mechanism to determine that the previous alignment was unsuccessful prior to workpiece processing.

### SUMMARY

The problems of the prior art are overcome by the mechanism and method of this disclosure. A workpiece support having alignment features to allow the proper alignment of the shadow mask to the workpiece is provided. The alignment features include tactile sensors, so as to measure the pressure being applied to each alignment feature. Based on these pressure readings, a determination can be made as to whether the workpiece is properly aligned with the shadow mask. In some embodiments, corrective actions may be initiated if a determination is made that the workpiece is not properly aligned.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 represents a traditional ion implantation system;

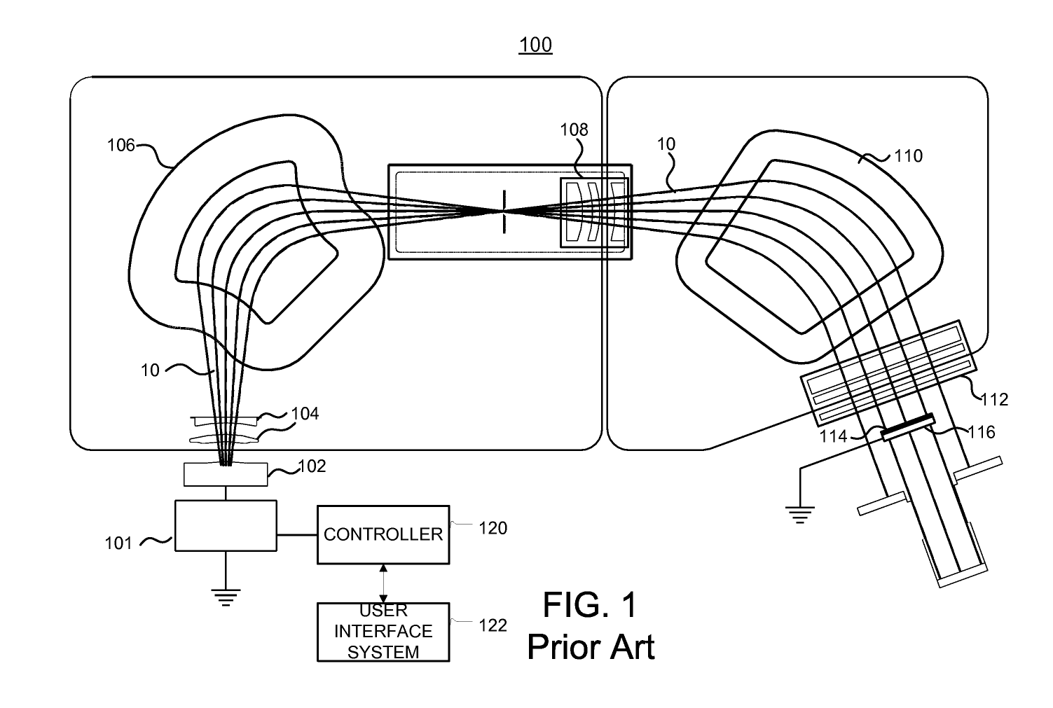

FIG. 2 represents a block diagram showing a workpiece support;

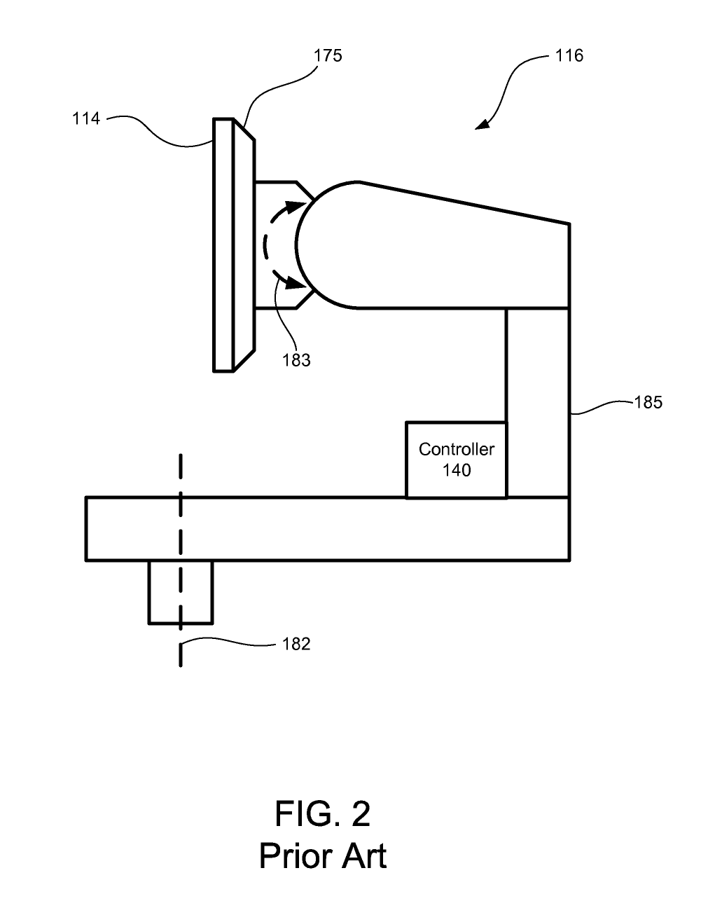

FIG. 3 represents a workpiece support having features for aligning a shadow mask and a workpiece;

FIG. 4 represents a workpiece support tilted to allow alignment of the workpiece;

FIG. 5 represents a misaligned workpiece;

FIG. 6 represents an embodiment according to the present disclosure; and

FIG. 7 illustrates a representative flowchart showing the alignment process according to an embodiment of the present disclosure.

### DETAILED DESCRIPTION

In the present disclosure, several embodiments of an apparatus and a method for aligning a workpiece and a shadow mask are introduced. For purpose of clarity and simplicity, the present disclosure will focus on an apparatus and a method for aligning a workpiece that is processed by a beam-line ion implanter. Those skilled in the art, however, may recognize that the present disclosure is equally applicable to other types of processing systems including, for example, a plasma immersion ion implantation (“PIII”) system, a plasma doping (“PLAD”) system, an etching system, an optical based processing system, and a chemical vapor deposition (CVD) system. As such, the present disclosure is not to be limited in scope by the specific embodiments described herein.

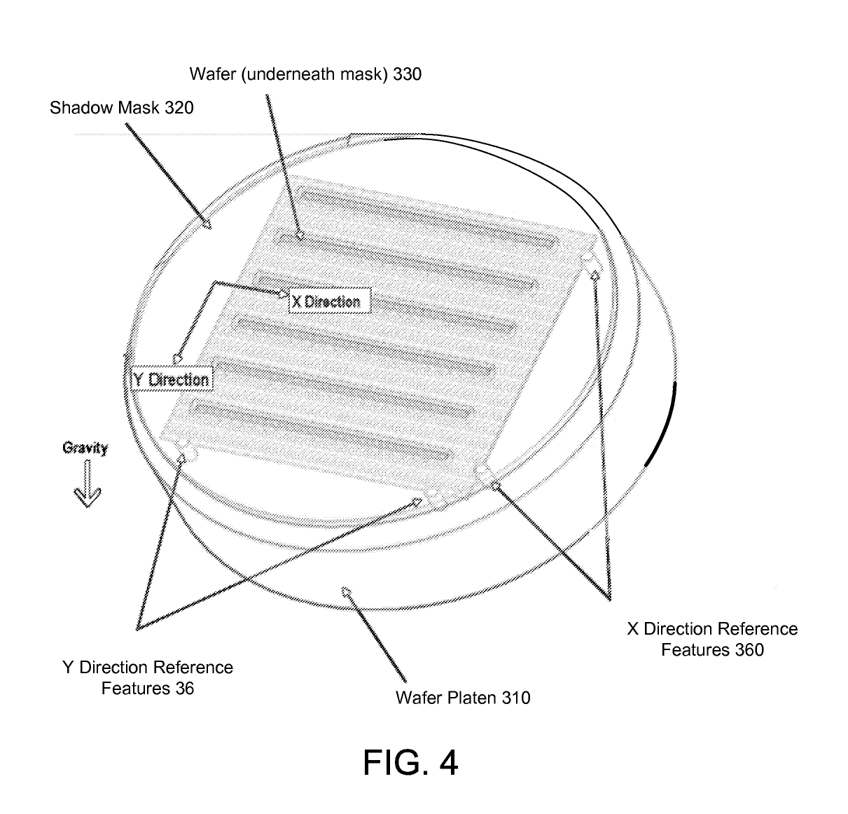

FIG. 4 shows the platen 310 oriented such that the workpiece 330 is tilted. Note that alignment features 361 exist which are used to align the workpiece 330 to the shadow mask 320 in the y dimension. When the platen 310 is tilted, as shown in FIG. 4, gravity-assisted alignment can be used with respect to alignment features 361. In some embodiments, alignment features 360 are included which are used to align the workpiece 330 to the shadow mask 320 in the x dimension. In this embodiment, the platen 310 may be capable of tilting about 2 or more axes. In some embodiments, the platen is capable of tilting about 2 axes simultaneously. In other embodiments, only alignment features 361 are used, as it is necessary to align the workpiece in the direction perpendicular to the long

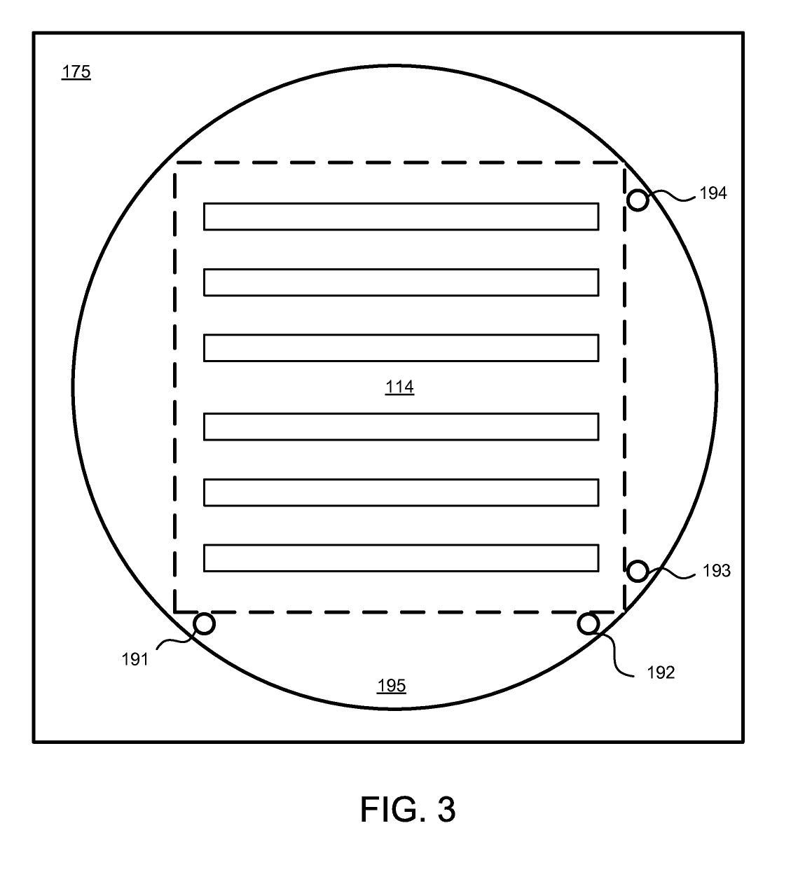

Returning to FIG. 3, the workpiece 114 is shown to be aligned in both directions with respect to alignment features 191-194. This illustrates a properly aligned workpiece that can be correctly processed. As described above, the alignment features 191-194 may be integral with the shadow mask 195. In other embodiments, the alignment features may be separate from the shadow mask 195 but have a predetermined relationship to the shadow mask. In other words, it is not critical that the alignment features be part of the shadow mask 195. If the shadow mask 195 and the workpiece 114 are each aligned to a common set of alignment features 191-194, then the workpiece 114 and shadow mask 195 are also aligned to each other.

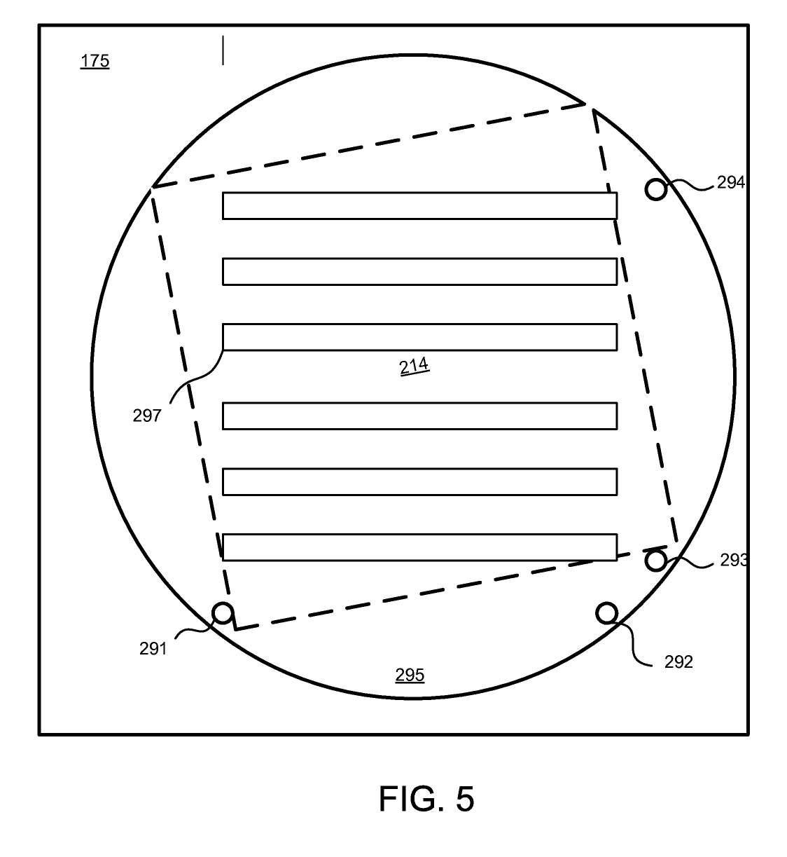

However, the tilting process described above does not always result in the proper alignment. FIG. 5 shows a workpiece 214 that is misaligned in relation to the shadow mask 295. In this embodiment, the workpiece 114 rests on alignment features 291 and 293, rather than 291 and 292 as intended. As a result, the ions may not be implanted in the proper regions of the workpiece 214. In this figure, it can be seen that the slits 297 on shadow mask 295 actually extend beyond the edge of the workpiece 214. While this figure is an exaggeration of the misalignment typically encountered, it illustrates the potential pitfalls of misalignment.

Currently, there are no techniques for verifying proper alignment of the workpiece to the shadow mask prior to commencement of workpiece processing. Therefore, even in the case of a misaligned workpiece, such as that shown in FIG. 5, the entire semiconductor process is performed on the workpiece. It is only after the workpiece exits the process chamber that it may be discovered that it was misaligned.

To overcome this shortcoming, a tactile sensor may be integrated in the alignment features. The tactile sensor can be of any suitable type, such as a micro stress gauge, or a resistive element whose resistance changes with pressure. The output of the tactile sensor can be of various types. For example, in one embodiment, the tactile sensor may have a binary output, which denotes that either pressure is being applied or no pressure is being applied to the sensor. In another embodiment, the output of the sensor may be a range of values, where the value is an indication of the amount of pressure being applied to the sensor. For example, greater values may indicate greater pressure being applied to the sensor. Furthermore, the output from the sensor may be analog or digital in format. In addition, the output of the sensor can be transmitted in any form, including wirelessly (such as but not limited to BlueTooth, Zigbee, 802.11a, 802.11b, 802.11g, and 802.11n protocols) and wired (including protocols such as USB). In other embodiments, a single wire is used for the output of the sensor, where the voltage of the output is indicative of the pressure applied to the sensor. In one particular embodiment, a tactile sensor having four connections is used. Two of the connections are power and ground connections. Two other connections are used to provide a differential voltage signal, which is indicative of the pressure applied to the sensor. The sensitivity of the tactile sensor may vary, and in some embodiments may be as sensitive as 0.25 mV/g.

A micro stress gauge may have 4 connections; power, ground and two for a differential output voltage. The differential output voltage may be linearly proportional to the pressure applied to the gauge. Although a linear relationship may be used, other relationships between the applied force and output voltage are also possible, including logarithmic and exponential. As long as the relationship between the output voltage and the applied pressure can be defined, any type of relationship may be employed. The micro stress gauge is placed such that it supports the workpiece when it is slide against the alignment features.

In the case of a pressure sensitive resistive element, an external circuit may be used to measure the resistance of the element. For example, a fixed voltage can be applied across the resistive element to determine its resistance by calculating the current passing through the element. In another embodiment, a fixed current is passed through the pressure sensitive resistive element, and the voltage across the element is used to calculate its resistance. This measured resistance is a measure of the pressure being applied to the resistive element.

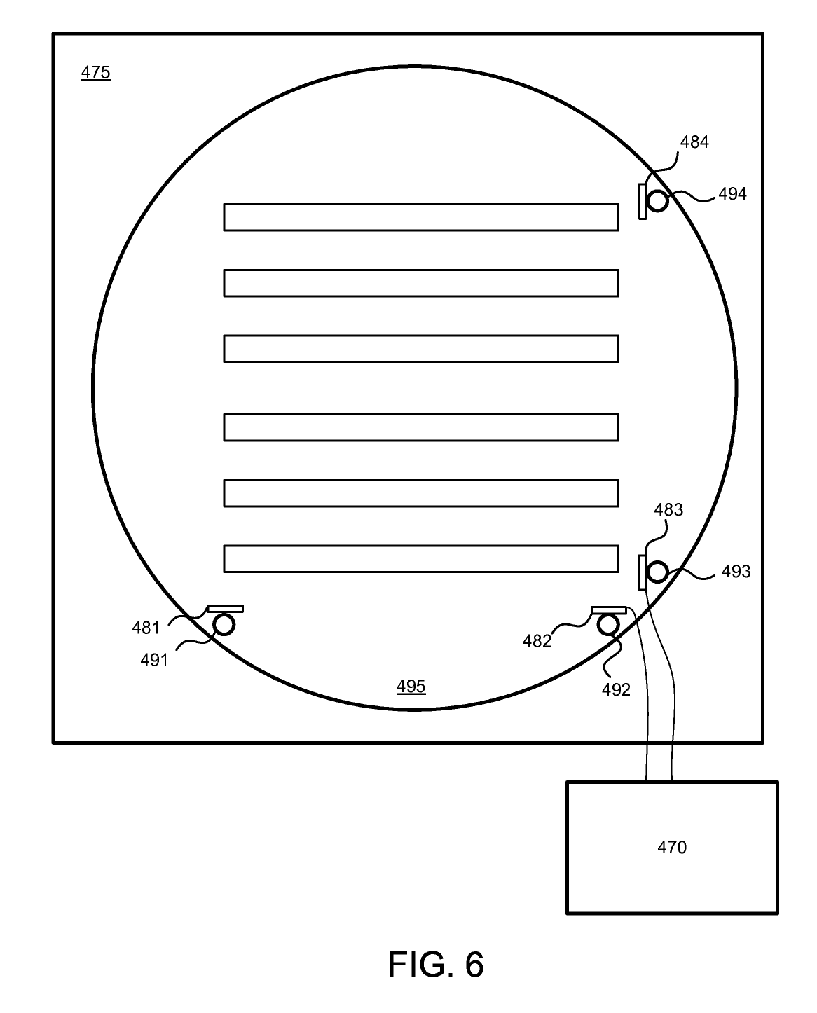

FIG. 6 shows a first embodiment. In this embodiment, the tactile sensors are pressure sensitive resistive elements. One such sensor 481-484 is positioned near or integral to each alignment feature 491-494. To monitor the resistance of the sensors, an external controller or circuit 470 is used to supply power (either voltage or current) to the various sensors 481-484. The resulting current or voltage is used to determine the resistance of each tactile sensor 481-484. In some embodiments, two wires are used for each resistive element. In other embodiments, one wire is used, where the other end of the resistive element is connected to a fixed voltage, such as ground. The measured resistance value can then be converted to an applied pressure value. Based on these values, a controller 470 may determine whether the workpiece is properly aligned.

In another embodiment, the tactile sensors are micro stress gauges. One such sensor 481-484 is positioned near or integral to each alignment feature 491-494. To monitor the force applied to each of the sensors, an external controller or circuit 470 is used to supply power (voltage and ground) to each of the various sensors 481-484. A differential voltage output is available as an output from each tactile sensor 481-484. In some embodiments, four wires are used for each micro stress gauge. The measured differential voltage can then be converted to an applied pressure value. Based on these values, a controller 470 may determine whether the workpiece is properly aligned.

In these embodiments, the controller 470 may comprise a processing unit, adapted to execute instructions and perform arithmetic operations. The controller may also comprise a storage element, which is configured to store the instructions to be executed by the processing unit. In addition, the storage element may store data. The storage element may be non-volatile, such as ROM, or may be volatile, such as RAM. In addition, the controller may include input and output ports to allow interaction with external components, such as the tactile sensors, and the tilt motors of the workpiece support. The processing unit may be any type, such as a general purpose processor, an embedded processor, or a special purpose processor design specifically for this task.

For example, FIG. 3 shows a properly aligned workpiece. In this case, the applied force measured by alignment features 191, 192 may be very similar, indicating that the workpiece 114 is evenly and equally balanced on both features. Upon detection of similar values, such as within a predetermined range, the controller 470 may conclude that the workpiece is properly aligned.

FIG. 4 shows a misaligned workpiece. In this case, the pressure indicated at alignment feature 291 may be accurate, or may be too high due to the extra pressure applied by the orientation of the workpiece. In contrast, the resistance measure at alignment feature 292 may indicate that there is no pressure being applied. Based on these values, the controller 470 may determine that the workpiece 214 is not properly aligned. The controller 470 may use a variety of techniques or algorithms to determine proper alignment. For example, in some embodiments, the controller 470 may compare the pressure applied to each of the alignment features in relation to one another. In other words, if the pressure being applied to each alignment feature in a particular direction is approximately equal, the controller may concluded that the workpiece must be evenly supported by the alignment features. In another embodiment, the magnitude of the applied pressure is used to determine whether the workpiece is pressed against the alignment feature. In other embodiments, a combination of these algorithms is used.

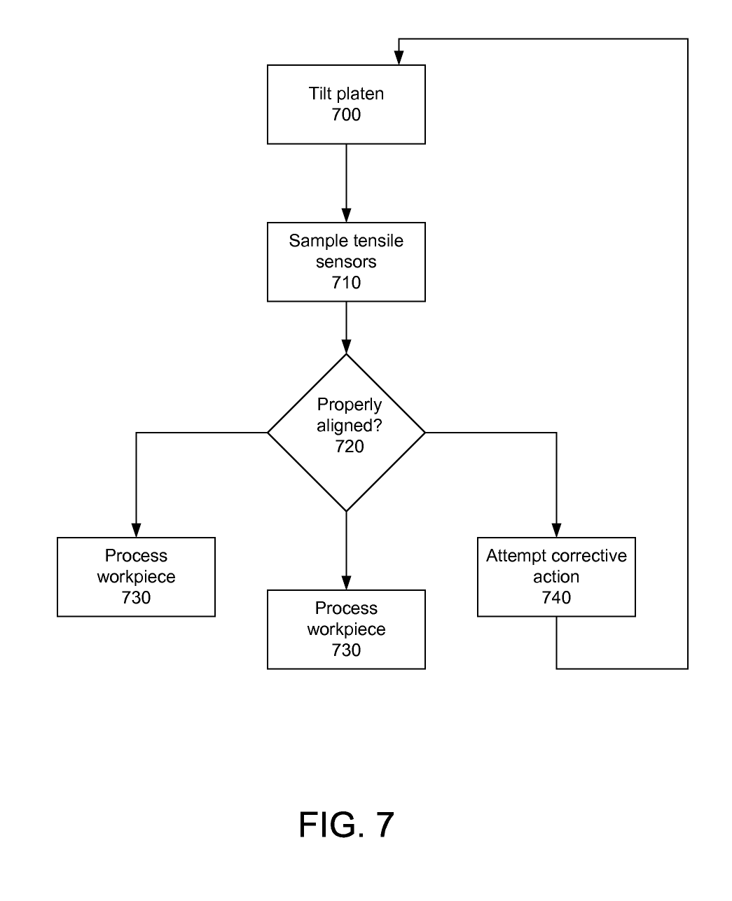

FIG. 7 shows a flowchart describing the operation of the controller. In step 700, the controller tilts the platen so that the workpiece may slide toward the alignment features. After an appropriate amount of time, the controller samples the outputs of all tactile sensors, as shown in step 710. Using one or more algorithms, the controller makes a determination as to whether the workpiece is properly aligned, as shown in step 720. This determination can be made using any suitable technique including those described earlier. If the workpiece is properly aligned, the alignment process is complete and the processing of the workpiece may begin, as shown in step 730. At this time, the workpiece may be clamped onto the platen, such as be electrostatic field. In addition, the platen may be tilted to a different position. If the workpiece is not aligned, the controller may attempt corrective action, as shown in step 740. In one embodiment, the controller may move the platen in an attempt to free the workpiece in the event that friction is holding it to the platen. In another embodiment, the controller may increase the angle of tilt such that gravity may be more effective in causing the workpiece to slide on the platen. After the attempted corrective action, the controller may repeat the entire alignment process by returning to step 700. In other embodiments, the controller may not attempt corrective action, or may be unsuccessful in doing so. In this case, the controller may alert the operator, as shown in step 750, such that the workpiece isn't processed unnecessarily.

In some embodiments, a number of different corrective actions may be available. In some embodiments, the controller may attempt a different corrective action after the initial alignment procedure failed. In some embodiments, the controller may perform a predetermined number of corrective actions before it stops. For example, the controller may attempt to correct the alignment three times before notifying the operator. In another embodiment, the controller may instruct the robotic system to unload the workpiece and proceed with the next workpiece. In other embodiments, the controller may not attempt any corrective action, and may simply stop and it determines that the workpiece is misaligned.

Furthermore, FIG. 3 shows that alignment features 191-194 may exist to allow alignment along two different axes. In this case, the controller 470 may perform the steps of FIG. 7 in one direction, and upon successful completion, attempt alignment in the second direction.

In other embodiments, the platen 175 is tilted at an angle such that the workpiece 114 slides toward all of the alignment features 191-194 in one operation. By performing alignment in two directions simultaneously, other corrective actions may be possible. For example, after tilting the platen 175, the controller 470 may determine that the workpiece 114 is properly aligned with respect to alignment features 191-192, but is not aligned at all with alignment features 193-194. In this case, the controller 470 may cause the platen 175 to alter the tilt angle to allow the workpiece 114 to slide toward the alignment features 193-194, while not affecting the alignment along features 191-192.

In some embodiments, the tactile sensors can be used to insure that the workpiece is not damaged. For example, in some embodiments, the controller can determine the weight of the workpiece based on the measurements received from the tactile sensors. If the workpiece has a predetermined weight, the controller can compare that weight to the measurements received from the tactile sensors. If the readings from the tactile sensors are outside of a predetermined range, the controller may conclude that the workpiece is defective. As an example, a workpiece may be damaged such that a corner or portion of it breaks off before or as it is being transferred to the platen. After the tilting process, the controller may determine that the workpiece is properly aligned (since the weight is evenly distributed between the alignment features). However, a check of the absolute readings may show that the values are lower than expected, indicating that the workpiece is lighter than usual. In another example, two workpieces may be stuck together. When this workpiece is placed on the platen, the controller may determine that the weight is much higher than expected.

In the case of a weight discrepancy, the controller may perform a corrective action. In some embodiments, the controller may stop operation of the equipment and alert the operator. In another embodiment, the controller may instruct the robotic system to unload the workpiece and proceed with the next workpiece.

Although the mask is described as a shadow mask, the disclosure is not limited to solely shadow masks. For example, the present disclosure may also be used to insure that stencil masks are properly to a workpiece.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A workpiece support for holding and aligning a workpiece, comprising a platen having a top surface onto which said workpiece is placed, comprising:
one or more alignment features, configured to align said workpiece to a mask, wherein each of said alignment features comprises a tactile sensor.

2. The workpiece support of claim 1, comprising a controller configured to receive outputs from said tactile sensors.

3. The workpiece support of claim 2, wherein said controller comprises a storage element, containing instructions adapted to determine whether said workpiece is properly alignment based on said outputs from said tactile sensors.

4. The workpiece support of claim 3, wherein said instructions are adapted to perform a corrective action if said determination indicates that said workpiece is not properly aligned.

5. The workpiece support of claim 4, wherein said corrective action comprises varying a tilt angle of said workpiece support.

6. The workpiece support of claim 4, wherein said correction action comprises notifying an operator.

7. The workpiece support of claim 1, wherein said tactile sensor comprises a pressure sensitive resistive element.

8. The workpiece support of claim 1, wherein said tactile sensor comprises a micro stress gauge.

9. The workpiece support of claim 3, wherein said instructions are adapted to determine whether the weight of said workpiece is within a predetermined range.

10. A method of aligning a workpiece to a mark on a platen, comprising:
providing alignment features on said platens, said alignment features having tactile sensors located on or adjacent to said alignment features;
placing a workpiece on said platen;
tilting said platen so that said workpiece slides toward said alignment features;
receiving information from said tactile sensors related to the pressure applied to each of said tactile sensors; and
determining the alignment of said workpiece, based on said received information.

11. The method of claim 10, further comprising performing a corrective action if said workpiece is determined not to be properly aligned.

12. The method of claim 11, wherein said corrective action comprises varying the tilt angle of said platen.

13. The method of claim 11, wherein said corrective action comprises alerting an operator.

14. The method of claim 10, wherein said tilting, receiving and determining steps are performed in two directions.

15. The method of claim 10, wherein said workpiece is processed by ion implantation equipment if said workpiece is determined to be properly aligned.

16. The method of claim 10, further comprising determining whether the weight of said workpiece is within a predetermined range.

17. The method of claim 16, further comprising taking corrective action is said weight is outside said predetermined range.

18. A workpiece support for holding and aligning a workpiece comprising:
a platen;
a mask clamped to said platen;
one or more alignment features affixed to said mask, wherein said alignment features comprise a tactile sensor.

19. The workpiece support of claim 18, comprising a controller configured to receive outputs from said tactile sensors.
